(19) United States
(12) Patent Application Publication
(10) Pub. No.: US 2026/0291705 A1
(43) Pub. Date: Sep. 24, 2026

(54) TRANSMISSION FORMAT INDICATOR FOR SUBBAND NON-OVERLAPPING FULL DUPLEX SLOT

(71) Applicant: Nokia Technologies Oy, Espoo (FI)

(72) Inventors: Jie Gao, Hangzhou (CN); Yuan Jing Sun, Beijing (CN); Nhat-Quang Nhan, Reims (FR); Youngsoo Yuk, Seoul (KR); Lal Sheyam Dhomeja, Espoo (FI)

(73) Assignee: Nokia Technologies Oy, Espoo (FI)

(21) Appl. No.: 19/475,089

(22) PCT Filed: Apr. 15, 2023
(86) PCT No.: PCT/CN2023/088553

§ 371 Date: Oct. 14, 2025

(51) Int. Cl. H04L 5/14; H04B 7/06; H04L 5/00

(52) U.S. Cl. CPC H04L 5/1438; H04B 7/0626; H04L 5/0044

(57) ABSTRACT

Example embodiments of the present disclosure relate to applying timing advance during random access procedure. The first apparatus receives from a second apparatus, configuration information comprising a transmission format indicator, wherein the transmission format indicator is to be applied to a sub-band or a group of sub-bands and is to be applied to a plurality of sub-resources in time domain comprised in a subband non-overlapping full duplex (SBFD) slot, wherein the plurality of sub-resources are a plurality of symbols comprising at least one SBFD symbol and at least one non-SBFD symbol; and performing, with the second apparatus, communications on the plurality of sub-resources based at least in part on the configuration information.

### FIELDS

Various example embodiments of the present disclosure generally relate to the field of telecommunication and in particular, to methods, devices, apparatuses and computer readable storage medium of transmission format indicator for subband non-overlapping full duplex (SBFD) slot.

### BACKGROUND

Currently, the new radio (NR) supports two duplexing modes: frequency division duplexing (FDD) for paired bands and time division duplexing (TDD) for unpaired bands. In TDD, the time domain resource is split between downlink (DL) and uplink (UL). Allocation of a limited time duration for the uplink in TDD would result in reduced coverage, increased latency, and reduced capacity.

To address the challenges above, a study on the evolution of duplexing operation in NR has been initiated. Subband non-overlapping full duplex (SBFD) has been proposed as a scheme of an enhanced duplex operation. In the SBFD, simultaneous DL transmission and UL reception on different physical resource blocks (PRBs) within an unpaired wideband NR cell is allowed. This duplexing scheme is also referred to as cross-division duplexing (xDD) or Flexible Duplexing (FDU).

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and perform, with the second apparatus, communications on the plurality of sub-resources based at least in part on the configuration information.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and perform, with the first apparatus, communications on the plurality of sub-resources based at least in part on the configuration information.

In a third aspect of the present disclosure, there is provided a method. The method comprises: at a first apparatus, receiving, from a second apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and performing, with the second apparatus, communications on the plurality of sub-resources based at least in part on the configuration information.

In a fourth aspect of the present disclosure, there is provided a method. The method comprises: at a second apparatus, transmitting, to a first apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and performing, with the first apparatus, communications on the plurality of sub-resources based at least in part on the configuration information.

In a fifth aspect of the present disclosure, there is provided a first apparatus. The first apparatus comprises means for receiving, from a second apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and means for performing, with the second apparatus, communications on the plurality of sub-resources based at least in part on the configuration information.

In a sixth aspect of the present disclosure, there is provided a second apparatus. The second apparatus comprises means for transmitting, to a first apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and means for performing, with the first apparatus, communications on the plurality of sub-resources based at least in part on the configuration information.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates a block of example duplexing modes;

FIG. 1C illustrates a block of SBFD resources and non-SBFD resources;

FIGS. 1D to 1I illustrate examples of slot combination;

FIG. 2 illustrates a signaling flow of communication in accordance with some embodiments of the present disclosure;

FIG. 3 illustrates an example slot combination;

FIGS. 4A and 4B illustrate examples of slot combination;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like.

As used herein, the terms “non-zero power (NZP) channel state information (CSI) reference signal (RS) for tracking RS (TRS)”, “CSI-RS for tracking”, “tracking RS, (TRS)” and “NZP CSI-RS” may be used interchangeably.

As used herein, the terms “symbol combination”, “time-domain locations of the CSI-RS resources in a slot” may be used interchangeably.

As discussed above, technology of SBFD has been proposed as a scheme of an enhanced duplex operation. Further, in order to further improve the flexibility of resource schedule, in some cases, an SBFD slot may comprise both SBFD symbol(s) and non-SBFD symbol(s), which causes that the resources schedule is more complicated. In view of this, how to reduce the implementation complexity while ensure the compatibility with legacy TDD DL/UL configuration needs to be discussed.

In the wireless communication system, communication of CSI RS is important for both the terminal device and the network device. Generally speaking, the resources for transmitting the CSI RS are scheduled by the network device. In some embodiments, as for SBFD-aware UEs, the frequency resource allocation for the CSI RS may across downlink subbands. Further, in one implementation, two contiguous CSI-RS resources that are linked may be allocated for the transmission of CSI RS. In another implementation, one CSI-RS resource may be allocated for the transmission of CSI RS. Further, the CSI-RS resource may be either a non-contiguous CSI-RS resource allocation, or a contiguous CSI-RS resource allocation with non-contiguous CSI-RS resource derived by excluding frequency resources outside DL subband(s).

In NR, the CSI-RS is used for a plurality of different purposes, and one purpose is to track frequency and time of the received DL signal.

In some embodiments, for an NZP-CSI-RS-ResourceSet configured with the higher layer parameter trs-Info, the terminal derive shall assume the antenna port with the same port index of the configured NZP CSI-RS resources in the NZP-CSI-RS-ResourceSet is the same.

In some embodiments, for frequency range 1, the terminal derive may be configured with one or more NZP CSI-RS set(s), where an NZP-CSI-RS-ResourceSet consists of four periodic NZP CSI-RS resources in two consecutive slots with two periodic NZP CSI-RS resources in each slot. If no two consecutive slots are indicated as DL slots by tdd-UL-DL-ConfigurationCommon or tdd-UL-DL-ConfigDedicated, the terminal derive may be configured with one or more NZP CSI-RS set(s), where an NZP-CSI-RS-ResourceSet consists of two periodic NZP CSI-RS resources in one slot.

In case of CSI RS for tracking RS, each CSI-RS resource may be configured by the higher layer parameter NZP-CSI-RS-Resource with some restrictions. One restriction is that the time-domain locations of the two CSI-RS resources should be in a slot, or the time-domain locations of the four CSI-RS resources should be in two consecutive slots (which are the same across two consecutive slots).

The time-domain locations of the two CSI-RS resources is defined by higher layer parameter CSI-RS-resourceMapping, which is given by one of {4, 8}, {5, 9}, {6, 10} for frequency range 1 (FR1) and frequency range 2 (FR 2) and {0, 4}, {1, 5}, {2, 6}, {3, 7}, {7, 11}, {8, 12} or {9, 13} for FR2. Another restriction is that the bandwidth of the CSI-RS resource, as given by the higher layer parameter freqBand configured by CSI-RS-ResourceMapping, is the minimum of 52 and N_{BWP,i}^{size} resource blocks, or is equal to N_{BWP,i}^{size} resource blocks.

An example of static TDD frame structure in one cell bandwidth is illustrated as below, for example, DDDSU, wherein D, S, U refer to DL slot, special slot, UL slot, respectively. In the special slot, there may be DL, UL, and Gap symbols.

An example of static TDD frame structure in one cell bandwidth

| | | | | |
|---|---|---|---|---|
| D | D | D | S | U |

An example of SBFD frame structure in one cell bandwidth is illustrated as below, for example, DUD with legacy frame structure DDDSU.

An example of SBFD frame structure in one cell bandwidth

| | | | | |
|---|---|---|---|---|
| D | D | D | S | U |
| D | U | U | U | U |
| D | D | D | S | U |

As discussed above, in case of FR1, two consecutive ‘D’ slots are required for TRS measurement. The traditional static TDD frame (such as the above illustrated DDDSU) usually has more than two consecutive ‘D’ slots, which can meet the requirement of transmitting CSI-RS for TRS in two consecutive DL slots and the configuration of CSI-RS for tracking with full bandwidth for time-frequency tracking of users in the cell.

However, in case of SBFD network, each slot may be configured with both UL and DL, and the UL may be in the middle of the frequency band, which interrupts the continuity of the DL RB. At the same time, the configuration of CSI-RS for TRS on specific symbols may conflict with the UL RB. In this event, if the CSI-RS for TRS is configured on the DL RB of the SBFD slot, the legacy measurement may be performed on this CSI-RS for tracking resources by either a legacy UE or an SBFD DL UE, but the SBFD UL UE cannot detect TRS, which causes that the communication performance of SBFD UL UE decreased.

In addition to the TRS transmission, other regular and common communications also may be influenced due to supporting SBFD slot comprising at least one SBFD symbol and at least one non-SBFD symbol.

In view of the above discussions, it is desirable to propose a more flexible solution of transmission format indicator for SBFD slot.

According to the present disclosure, the first apparatus (such as, a terminal device) receives configuration information from a second apparatus, where the configuration information comprises a transmission format indicator. In particular, the transmission format indicator is to be applied to a sub-band or a group of sub-bands and is to be applied to a plurality of sub-resources in time domain comprised in an SBFD slot, where the plurality of sub-resources are a plurality of symbols composing at least one SBFD symbol and at least one non-SBFD symbol. Then the first apparatus performs communications with the second apparatus on the plurality of sub-resources based at least in part on the configuration information.

The sub-band or group of sub-bands may be understood as sub-band(s) of a frequency band of a carrier or a frequency band configured for the SBFD slot.

The legacy solution only support configure transmission format indicator for the total frequency band, which causes that certain regular and common communications, such as, measuring TRS, may be failed at the SBFD UE sometimes. According to the present discourse, the transmission format indicator is to be applied to a sub-band or a group of sub-bands and is to be applied to a plurality of sub-resources in time domain comprised in an SBFD slot. In this way, the schedule flexibility is enhanced, and the regular and common communications may be well supported by the SBFD UE.

### Example Environment

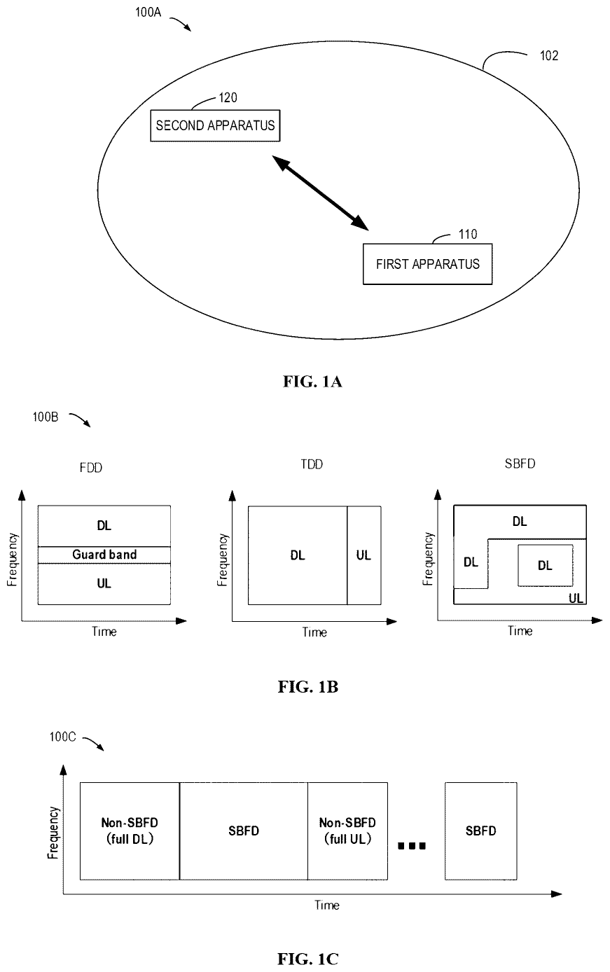

FIG. 1A illustrates an example communication environment 100A in which example embodiments of the present disclosure can be implemented. The communication environment 100A includes a first apparatus 110 and a second apparatus 120. A serving area provided by the second apparatus 120 is called a cell. Further, the second apparatus 120 can provide one or more cells, for example, a cell 102 is provided by the second apparatus 120, as illustrated in FIG. 1A.

In some example embodiments, the first apparatus 110 may be comprised in a terminal device/apparatus and the second apparatus 120 may be comprised in a network device/apparatus serving the terminal device/apparatus.

In the following, for the purpose of illustration, some example embodiments are described with the first apparatus 110 operating as a terminal apparatus and the second apparatus 120 operating as a network apparatus. However, in some example embodiments, operations described in connection with a terminal apparatus may be implemented at a network apparatus or other apparatus, and operations described in connection with a network apparatus may be implemented at a terminal apparatus or other apparatus.

In some example embodiments, if the first apparatus 110 is a terminal apparatus and the second apparatus 120 is a network apparatus, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) apparatus (or a transmitter) and the first apparatus 110 is a receiving (RX) apparatus (or a receiver). In UL, the first apparatus 110 is a TX apparatus (or a transmitter) and the second apparatus 120 is a RX apparatus (or a receiver).

Communications in the communication environment 110A may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Multiple duplexing modes may be supported in communication environment 100A. Reference is now made to FIG. 1B, which illustrates blocks 100B of three example duplexing modes, i.e., TDD, FDD and SBFD.

The FDD may be used for paired bands and TDD may be used for unpaired bands. In TDD, the time domain resource is split between DL and UL. Allocation of a limited time duration for the UL in TDD would result in reduced coverage, increased latency, and reduced capacity. The SBFD may be considered as an evolution of duplexing operation in NR. In particular, the SBFD may allow simultaneous DL and UL transmission on different physical resource blocks (PRBs)/sub-bands within an unpaired wideband NR cell, as illustrated in FIG. 1B.

In some embodiments, an SBFD slot may comprise both SBFD symbol(s) and non-SBFD symbol(s).

Further, different duplexing modes may be used interactively. In view of this, there may be two resource types for both DL and UL transmissions, namely:
SBFD resources (such as, slots), in which the non-overlapping DL sub-bands and UL subband(s) both exist, and
Non-SBFD resources (such as, slots), in which the entire band is used for either DL or UL (i.e., full DL/UL slots).

For a better understanding, reference is now made to FIG. 1C, which illustrates a block 100C of SBFD resources and non-BFD resources.

For a further understanding, reference is now made to FIGS. 1D to 1I, which illustrated some slot combinations 100D to 100I. In FIGS. 1D to 1I, there are many slot combinations having both SBFD and non-SBFD symbols.

It should be understood that system synchronization block (SSB), system information block (SIB), paging message, common message, TRS, physical downlink control channel (PDCCH), physical DL shared channel (PDSCH) are illustrated as examples DL transmission marked in FIGS. 1D to 1I, sounding reference signal (SRS), physical uplink control channel (PUCCH), physical uplink shared channel (PUSCH) and physical random-access channel (PRACH) are used as examples of UL transmission marked in FIGS. 1D to 1I, which are given for illustrative purpose only. In other words, the resources configured for UL may be used for transmitting any suitable type(s) of UL transmission, the resources configured for DL may be used for transmitting any suitable type(s) of DL transmission. The present disclosure is not limited in this regard.

In some embodiments, at least the operation mode with time and frequency locations of sub-bands for SBFD operation may be known to the SBFD-aware UE. That is, the SBFD slots should be known by the (SBFD-aware) UE.

### Work Principle and Example Signaling for Communication

As discussed, in case that both SBFD resource (such as, SBFD slot/symbol) and non-SBFD resource (such as, non-SBFD slot/symbol) are supported, some regular and common communications also may be influenced. For example, the SBFD-aware UEs may face problems in measuring/receiving CSI-RS for TRS if legacy configuration of CSI-RS for tracking for FR1 is applied, i.e., the two/four CSI-RS resources in two consecutive slots (which are the same across two consecutive slots) are configured.

According to some example embodiments of the present disclosure, there is provided a solution of transmission format indicator for SBFD. With the example embodiments discussed below, the schedule flexibility is enhanced, and the regular and common communications may be well supported by the SBFD UE.

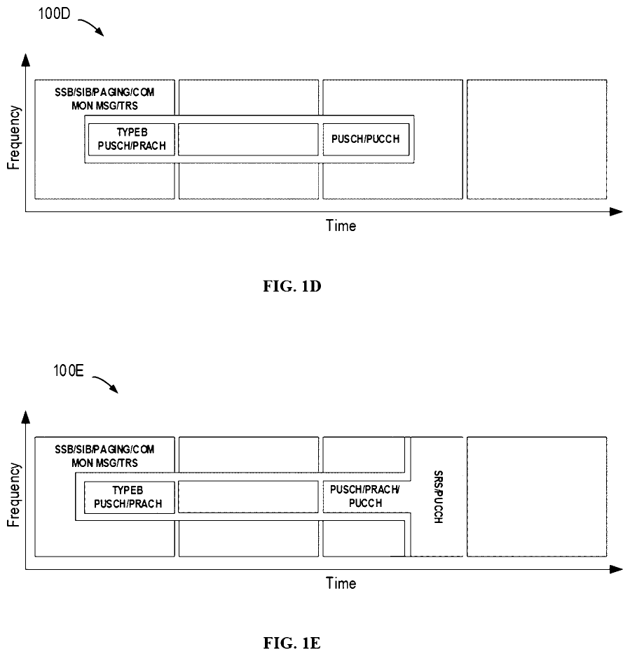

Reference is made to FIG. 2, which illustrates a signaling flow 200 of communication in accordance with some embodiments of the present disclosure. For the purposes of discussion, the signaling flow 200 will be discussed with reference to FIGS. 1A to 1I, for example, by using the first apparatus 110 and the second apparatus 120.

It is to be understood that the operations at the first apparatus 110 and the second apparatus 120 should be coordinated. In other words, the second apparatus 120 and the first apparatus 110 should have common understanding about configurations, parameters and so on. Such common understanding may be implemented by any suitable interactions between the second apparatus 120 and the first apparatus 110 or both the second apparatus 120 and the first apparatus 110 applying the same rule/policy.

In the following, although some operations are described from a perspective of the first apparatus 110, it is to be understood that the corresponding operations should be performed by the second apparatus 120. Similarly, although some operations are described from a perspective of the second apparatus 120, it is to be understood that the corresponding operations should be performed by the first apparatus 110. Merely for brevity, some of the same or similar contents are omitted here.

In addition, in the following description, examples of message type (such as “RRC message”, “DCI”) are only for the purpose of illustration without suggesting any limitations. In other example embodiments, any suitable message types may be used for the interaction between the first apparatus 110 and the second apparatus 120.

In the example of FIG. 2, the first apparatus 110 is a terminal apparatus and the second apparatus 120 is a network apparatus.

In operation, the first apparatus 110 receives 220 configuration information from the second apparatus 120, where the configuration information comprises a transmission format indicator. In particular, the transmission format indicator is to be applied to a sub-band or a group of sub-bands and is to be applied to a plurality of sub-resources in time domain comprised in an SBFD slot, where the plurality of sub-resources are a plurality of symbols composing at least one SBFD symbol and at least one non-SBFD symbol.

Then the first apparatus 110 performs 230 communications with the second apparatus 120 on the SBFD slot (i.e., the plurality of sub-resources) based at least in part on the configuration information.

In summary, different from the legacy solution where the transmission format indicator is configured for the total frequency band, according to the present disclosure, the transmission format indicator is to be applied to a sub-band or a group of sub-bands and is to be applied to a plurality of sub-resources in time domain comprised in an SBFD slot. In this way, the schedule flexibility is enhanced, and the regular and common communications may be well supported by the SBFD UE.

More details about the transmission format indicator will be discussed as below.

In some example embodiments, the transmission format indicator is a subband slot format indicator (SFI) for the SBFD slot.

In some example embodiments, the transmission format indicator may indicate the first part of the plurality of sub-resources are used for UL transmissions. Alternatively, in some example embodiments, the transmission format indicator may indicate the last part of the plurality of sub-resources are used for DL transmissions.

In this way, the UL symbols provide longer UL time duration for UL coverage and data transmission, while the DL symbols at the end of the slot may be used for quick scheduling of the following slots, especially for following UL transmissions in the following slots, such that the latency for UL scheduling is reduced.

Alternatively, in some example embodiments, the transmission format indicator may indicate the last part of the plurality of sub-resources are used for UL transmissions. Alternatively, in some example embodiments, the transmission format indicator may indicate the first part of the plurality of sub-resources are used for DL transmissions.

Below table 1 illustrates some examples of transmission format, wherein D, F, U refer to DL symbol, flexible symbol, UL symbol, respectively.

TABLE 1
Examples of transmission format

| transmission | Index of symbol | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | F | F | U | U | U | U | U | U |
| 1 | U | U | U | U | U | U | F | D | D | D | D | D | D | D |
| 2 | U | U | U | U | U | U | F | F | D | D | D | D | D | D |
| 3 | D | D | D | D | D | D | F | U | U | U | U | U | U | U |
| 4 | D | D | D | D | D | D | D | F | U | U | U | U | U | U |
| 5 | U | U | U | U | U | U | D | D | D | D | D | D | D | D |
| 6 | U | U | U | U | U | U | F | D | D | D | D | D | D | D |

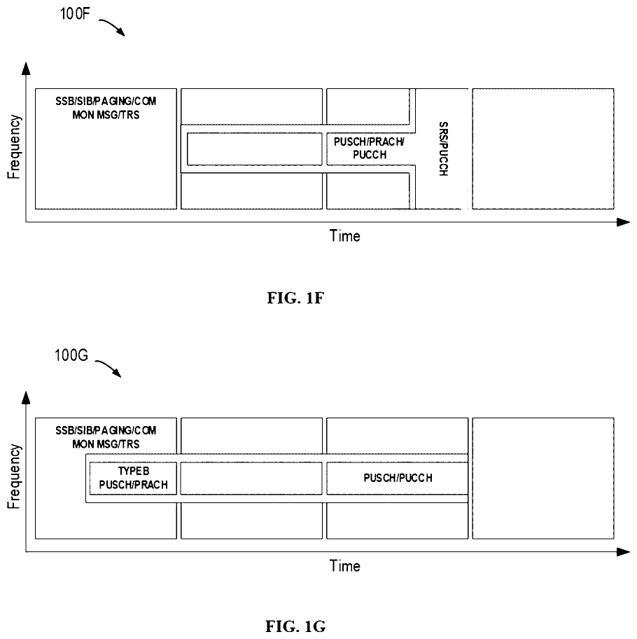

For a better understanding, reference is now made to FIG. 3, which illustrates an example slot combination 300.

In FIG. 3, there are some slots that consist of both SBFD and non-SBFD symbols (such as, slot #0). As for slot #0, it may be configured with format #4 (i.e., {DDDDDDDFUUUUUU}), where the format #4 is to be applied only for the subband that contain UL transmission (also referred to as SBFD subband, hereinafter).

As one example embodiment, with the above transmission format indicator, the first apparatus 110 may perform UL transmissions first and then operate with the DL reception mode, for example, firstly one or more UL symbols and then one or more DL symbols. Further, there can be 0/1/2/N symbols (i.e., F symbol) between UL and DL symbols for processing switching from UL to DL).

In some example embodiments, if the SBFD slot is the first slot of the plurality of slots, the format indicator may indicate the last part of the plurality of sub-resources are used for UL transmissions. In some example embodiments, if the SBFD slot is the last slot of the plurality of slots, the format indicator indicates the first part of the plurality of sub-resources are used for UL transmissions.

As one example embodiment, in case of the plurality of slots, the above transmission format indicator nay be provided together with other legacy slot format. For example, there is a continuous UL symbol duration, including several symbols (for example, 6 symbols in slot #0), then several slots (for example, slots #1, #2, #3), then several symbols (6 symbols in slot #4), which provide a continuous UL duration for more than 1 slot. In this case, slot #0 may be configured with format #0, and slot #4 may be configured with format #2. Further slots #1, #2, #3 may be configured as UL SBFD slot.

In this specific embodiment, the last slot is configured with format #2, which provides more chance for DL transmission in the last several symbols for PDCCH, and the first apparatus may obtain a continuous UL schedule.

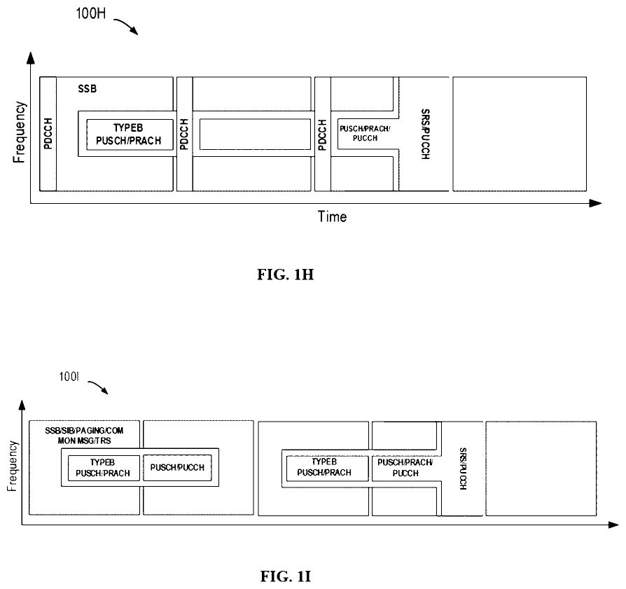

In some example embodiments, the SBFD slot may be periodic or aperiodic (i.e., a part of periodic or aperiodic resources). For a better understanding, reference is now made to FIG. 4A, which illustrates an example slot combination 400A. In FIG. 4A, there are some periodic or aperiodic special configuration slots that have both SBFD and non-SBFD symbols, e.g., slots #1 and #2 are not normal periodic slots. Further, slots #1 and #2 have both SBFD and non-SBFD symbols. In this event, slot #1 may be configured with format #1, and slot #2 may be configured with format #4. These two slots may be periodic (or aperiodic).

In some example embodiments, the configuration information may further indicate an NZP CSI RS for TRS configuration, and thus both UL transmissions and TRS transmissions may be performed by the UE within one slot. Further, the requirement of two consecutive ‘D’ slots for FR1 TRS and consecutive ‘U’ slots for UL coverage enhancement may be satisfied.

In summary, with the CSI-RS for TRS configuration and the above transmission format indicator, the SBFD UEs may support more flexible configuration of CSI-RS for TRS, generally a reference signal, with two separate symbol positions outside of UL symbols (or symbols with SBFD UL subband) in the two continuous slots. At the same time, the SBFD UE may monitor TRS while performing UL traffic in one SBFD slot.

Still refer to FIG. 2, in some example embodiments, when performing communications with the second apparatus, the first apparatus 110 transmits 232 UL transmissions to the second apparatus 120 based on the transmission format indicator and the NZP CSI RS for tracking RS configuration. Additionally, the first apparatus 110 receives 234 NZP CSI RS for tracking RS from the second apparatus 120 based on the NZP CSI RS for tracking RS configuration. Some details are discussed as below.

In some example embodiments, in addition to the transmission format indicator, the configuration information further comprises an NZP CSI RS for TRS configuration for two consecutive slots comprising an SBFD slot and a further slot (which may be a SBFD slot or a non-SBFD slot).

In some example embodiments, the NZP CSI RS for TRS configuration and the transmission format indicator are comprised in the same message or at least two different messages.

As one example embodiment, the first apparatus 110 may receive configuration information comprising the transmission format indicator first (such as, via an RRC signalling), and then receive configuration information comprising NZP CSI RS for TRS configuration (such as, via a further RRC signalling or DCI).

Alternatively, in another example embodiment, the first apparatus 110 may receive configuration information comprising both the transmission format indicator first and the NZP CSI RS for TRS configuration (such as, via one RRC signalling).

In some example embodiments, the two consecutive slots are periodic or aperiodic slots.

In some example embodiments, the NZP CSI RS for TRS configuration may indicate a same symbol combination corresponding to the two consecutive slots, where the symbol combination indicates resources (i.e., the time-domain locations) used for transmitting the NZP CSI RS for TRS.

Alternatively, in some example embodiments, the NZP CSI RS for TRS configuration may indicate two different symbol combinations corresponding to the SBFD slot and the further slot respectively, where the symbol combinations indicate the resources (i.e., the time-domain locations) used for transmitting the NZP CSI RS for tracking RS.

In summary, in some example embodiments, the time-domain locations (i.e., the symbol combination) of the two CSI-RS resources in a slot, or the time-domain locations of the four CSI-RS resources in two consecutive slots may be the same or different across two consecutive slots.

Further, in some example embodiments, the time-domain locations (i.e., the symbol combination) may be defined by higher layer parameter CSI-RS-resourceMapping.

For a better understanding, reference is now made to FIG. 4A. In FIG. 4A, the TRSs may be received on different symbol sets (i.e., different symbol combinations) in the consecutive slots.

In the specific example of FIG. 4A, the first apparatus 110 may measure periodically TRSs in slot #0 and slot #1, wherein TRSs are placed in symbols of {2, 6} in slot #0 and placed in symbols of {7, 11} in slot #1.

Alternatively, the first apparatus 110 may measure TRSs in slot #0 and slot #1 aperiodically. In some example embodiments, the aperiodic TRS measurement may be triggered by the second apparatus 120. Specifically, the second apparatus 120 may indicate the first apparatus 110 to measure TRSs, and indicate the TRSs are placed in symbols of {2, 6} in slot #0 and placed in symbols of {7, 11} in slot #1.

Reference is now made to FIG. 4B, which illustrates an example slot combination 400B. In FIG. 4B, the TRSs may be received on the same symbol sets (i.e., the same symbol combination) in the two consecutive slots.

In some example embodiments, the first apparatus 110 measures TRSs in slot #0 and slot #1 periodically, wherein the TRSs are placed in symbols of {2, 6} in slot #0 and slot #1.

Alternatively, in some example embodiments, the first apparatus 110 may measure the TRSs in slot #0 and slot #1 aperiodically, wherein the TRSs are placed in symbols of {2, 6} in slot #0 and slot #1. In some example embodiments, the aperiodic TRS measurement may be triggered by the second apparatus 120. Specifically, the second apparatus 120 may indicate the first apparatus 110 to measure TRSs, and indicate the TRSs are placed in symbols of {2, 6} in slot #0 and slot #1.

In some example embodiments, in case of FR1, the symbol combination is one of the following {0, 4}, {1, 5}, {2, 6}, {3, 7}, {4, 8}, {5, 9}, {6, 10}, {7, 11}, {8, 12} or {9, 13}.

In some example embodiments, in case of FR2, the symbol combination is one of the following {0, 4}, {1, 5}, {2, 6}, {3, 7}, {4, 8}, {5, 9}, {6, 10}, {7, 11}, {8, 12} or {9, 13}.

Optionally, in some example embodiments, the configuration information may indicate SBFD-related information to the first apparatus 110. As one example embodiment, the configuration information may indicate at least one of the following:
a frequency band;
a number of slots/symbols wherein the frequency band is split into multiple subbands and wherein at least one subband is used for DL transmissions and at least one subband is used for UL transmissions, i.e., SBFD slots/symbols, and locations of the number of slots/symbols in a radio frame;
a number of slots/symbols wherein the entire frequency band is used for DL transmissions or UL transmissions, i.e., non-SBFD slots/symbols, and locations of the number of slots/symbols in a radio frame; or
Common TDD frame structure configuration, e.g., DDDSU (pattern1).

An example of configuration information that indicates the SBFD-related information is illustrated as below.

TDD-UL-DL-ConfigCommon ::= SEQUENCE {

| | |
|---|---|
| referenceSubcarrierSpacing | SubcarrierSpacing, |

| | |
|---|---|
| pattern1 | TDD-UL-DL-Pattern, |

}
TDD-UL-DL-Pattern ::= SEQUENCE {

| | |
|---|---|
| dl-UL-TransmissionPeriodicity | ENUMERATED {ms2p5}, |
| nrofDownlinkSlots | INTEGER (3), |
| nrofDownlinkSymbols | INTEGER (10), |

| | |
|---|---|
| nrofUplinkSlots | INTEGER (1), |

| | |
|---|---|
| nrofUplinkSymbols | INTEGER (2). |

It should be understood, the configuration information may comprise other parameters according to the specific scenario. The present disclosure is not limited in this regard.

Further, in some example embodiments, the supporting SBFD may be implemented as a configurable/optional feature. Still refer to FIG. 2, the first apparatus 110 may enable 210 the SBFD mode by itself or by the second apparatus 120.

According to the above processes, by introducing the transmission format indicator which may be applied to a sub-band (or a group of sub-bands), the schedule flexibility is enhanced, and the regular and common communications may be well supported by the SBFD UE. Especially, the newly-introduced transmission format indicator achieves a more flexible SBFD structure, which especially benefits CSI-RS for TRS in case of FR1.

### Example Methods

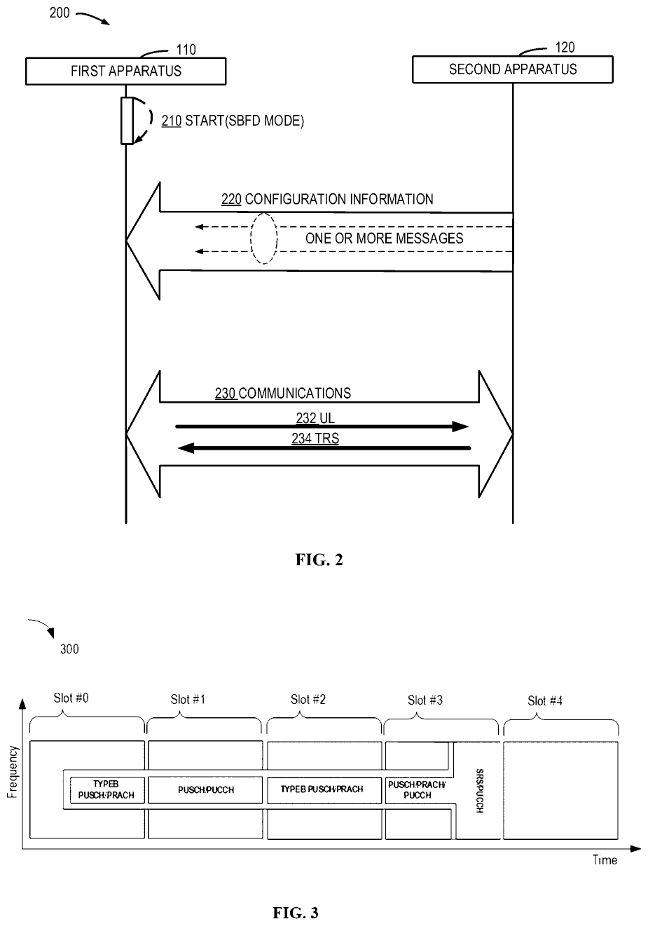

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1A.

At block 510, the first apparatus 110 receives, from a second apparatus 120, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol.

At block 520, the first apparatus 110 performs, with the second apparatus 120, communications on the plurality of sub-resources based at least in part on the configuration information.

In some example embodiments, the transmission format indicator may indicate the first part of the plurality of sub-resources are used for uplink transmissions.

Alternatively, in some example embodiments, the transmission format indicator may indicate the last part of the plurality of sub-resources are used for uplink transmissions.

Alternatively, in some example embodiments, the transmission format indicator may indicate the first part of the plurality of sub-resources are used for downlink transmissions.

Alternatively, in some example embodiments, the transmission format indicator may indicate the last part of the plurality of sub-resources are used for downlink transmissions.

In some example embodiments, the SBFD slot belongs to a plurality of continuous slots, and if the SBFD slot is the first slot of the plurality of slots, the format indicator may indicate the last part of the plurality of sub-resources are used for uplink transmissions.

In some example embodiments, the SBFD slot belongs to a plurality of continuous slots, and if the SBFD slot is the last slot of the plurality of slots, the format indicator may indicate the first part of the plurality of sub-resources are used for uplink transmissions.

In some example embodiments, the configuration information may further comprise: an NZP CSI RS for TRS configuration for two consecutive slots comprising the SBFD slot and a further slot.

In some example embodiments, the NZP CSI RS for TRS configuration indicates a same symbol combination corresponding to the two consecutive slots, indicating resources used for transmitting the NZP CSI RS for tracking RS.

Alternatively, in some example embodiments, the NZP CSI RS for TRS configuration indicates two different symbol combinations corresponding to the SBFD slot and the further slot respectively, indicating the resources used for transmitting the NZP CSI RS for TRS.

In some example embodiments, in case of FR1, the symbol combination may be one of the following {0, 4}, {1, 5}, {2, 6}, {3, 7}, {4, 8}, {5, 9}, {6, 10}, {7, 11}, {8, 12} or {9, 13}.

In some example embodiments, performing the communications with the second apparatus 120 may comprise: performing, based on the transmission format indicator and the NZP CSI RS for tracking RS configuration, the communications on the SBFD slot, the communications comprising: transmitting uplink transmissions to the second apparatus 120, and receiving NZP CSI RS for tracking RS from the second apparatus 120.

In some example embodiments, the two consecutive slots may be periodic or aperiodic slots.

In some example embodiments, the NZP CSI RS for TRS configuration and the transmission format indicator may be comprised in the same message or at least two different messages.

In some example embodiments, the transmission format indicator may be a subband SFI.

In some example embodiments, the first apparatus 110 may a terminal apparatus and the second apparatus 120 may be a network apparatus.

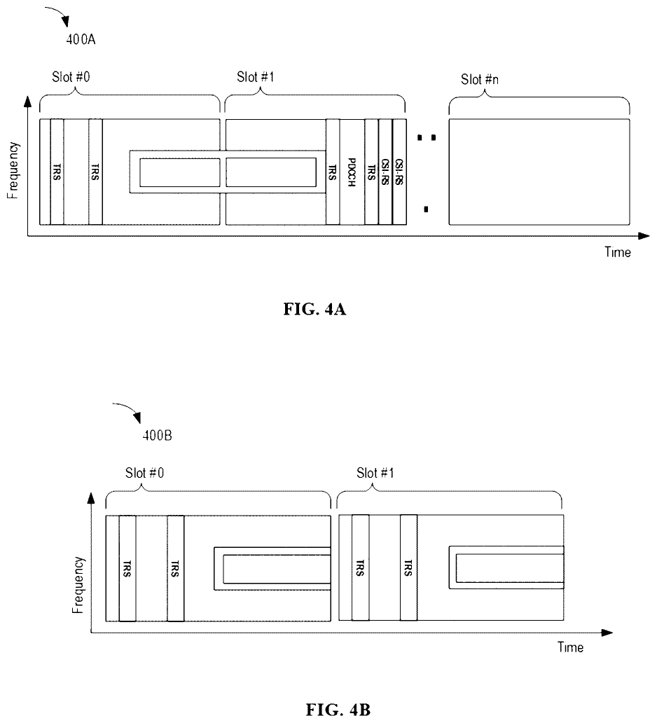

FIG. 6 shows a flowchart of an example method 600 implemented at a second device in accordance with some example embodiments of the present disclosure. For the purpose of discussion, the method 600 will be described from the perspective of the second apparatus 120 in FIG. 1A.

At block 610, the second apparatus 120 transmits, to a first apparatus 110, configuration information comprising a transmission format indicator, wherein the transmission format indicator is to be applied to a sub-band or a group of sub-bands and is to be applied to a plurality of sub-resources in time domain comprised in a subband non-overlapping full duplex (SBFD) slot, wherein the plurality of sub-resources are a plurality of symbols comprising at least one SBFD symbol and at least one non-SBFD symbol.

At block 620, the second apparatus 120 performs, with the first apparatus 110, communications on the plurality of sub-resources based at least in part on the configuration information.

In some example embodiments, the transmission format indicator may indicate the first part of the plurality of sub-resources are used for uplink transmissions.

Alternatively, in some example embodiments, the transmission format indicator may indicate the last part of the plurality of sub-resources are used for uplink transmissions.

Alternatively, in some example embodiments, the transmission format indicator may indicate the first part of the plurality of sub-resources are used for downlink transmissions.

Alternatively, in some example embodiments, the transmission format indicator may indicate the last part of the plurality of sub-resources are used for downlink transmissions.

In some example embodiments, the SBFD slot belongs to a plurality of continuous slots, and if the SBFD slot is the first slot of the plurality of slots, the format indicator may indicate the last part of the plurality of sub-resources are used for uplink transmissions.

In some example embodiments, the SBFD slot belongs to a plurality of continuous slots, and if the SBFD slot is the last slot of the plurality of slots, the format indicator may indicate the first part of the plurality of sub-resources are used for uplink transmissions.

In some example embodiments, the configuration information further comprises: an NZP CSI RS for TRS configuration for two consecutive slots comprising the SBFD slot and a further slot.

In some example embodiments, the NZP CSI RS for TRS configuration indicates a same symbol combination corresponding to the two consecutive slots, indicating resources used for transmitting the NZP CSI RS for tracking RS.

Alternatively, in some example embodiments, the NZP CSI RS for TRS configuration indicates two different symbol combinations corresponding to the SBFD slot and the further slot respectively, indicating the resources used for transmitting the NZP CSI RS for TRS.

In some example embodiments, in case of frequency range 1 (FR1), the symbol combination may be one of the following {0, 4}, {1, 5}, {2, 6}, {3, 7}, {4, 8}, {5, 9}, {6, 10}, {7, 11}, {8, 12} or {9, 13}.

In some example embodiments, performing the communications with the second apparatus 120 may comprise: performing, based on the transmission format indicator and the NZP CSI RS for tracking RS configuration, the communications on the SBFD slot, the communications comprising: receiving uplink transmissions from the first apparatus 110, and transmitting NZP CSI RS for tracking RS to the first apparatus 110.

In some example embodiments, the two consecutive slots may be periodic or aperiodic slots.

In some example embodiments, the NZP CSI RS for tracking RS configuration and the transmission format indicator may be comprised in the same message or at least two different messages.

In some example embodiments, the transmission format indicator may be a subband SFI.

In some example embodiments, the first apparatus 110 may a terminal apparatus and the second apparatus 120 may be a network apparatus.

### Example Apparatus, Device and Medium

In some example embodiments, a first apparatus capable of performing any of the method 500 (for example, the first apparatus 110 in FIG. 1A may comprise means for performing the respective operations of the method 500. The means may be implemented in any suitable form. For example, the means may be implemented in a circuitry or software module. The first apparatus may be implemented as or included in the first apparatus 110 in FIG. 1A.

In some example embodiments, the first apparatus comprises means for receiving, from a second apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and means for performing, with the second apparatus, communications on the plurality of sub-resources based at least in part on the configuration information.

In some example embodiments, the transmission format indicator may indicate the first part of the plurality of sub-resources are used for uplink transmissions.

Alternatively, in some example embodiments, the transmission format indicator may indicate the last part of the plurality of sub-resources are used for uplink transmissions.

Alternatively, in some example embodiments, the transmission format indicator may indicate the first part of the plurality of sub-resources are used for downlink transmissions.

Alternatively, in some example embodiments, the transmission format indicator may indicate the last part of the plurality of sub-resources are used for downlink transmissions.

In some example embodiments, the SBFD slot belongs to a plurality of continuous slots, and if the SBFD slot is the first slot of the plurality of slots, the format indicator may indicate the last part of the plurality of sub-resources are used for uplink transmissions.

In some example embodiments, the SBFD slot belongs to a plurality of continuous slots, and if the SBFD slot is the last slot of the plurality of slots, the format indicator may indicate the first part of the plurality of sub-resources are used for uplink transmissions.

In some example embodiments, the configuration information may further comprise: an NZP CSI RS for TRS configuration for two consecutive slots comprising the SBFD slot and a further slot.

In some example embodiments, the NZP CSI RS for TRS configuration indicates a same symbol combination corresponding to the two consecutive slots, indicating resources used for transmitting the NZP CSI RS for tracking RS.

Alternatively, in some example embodiments, the NZP CSI RS for TRS configuration indicates two different symbol combinations corresponding to the SBFD slot and the further slot respectively, indicating the resources used for transmitting the NZP CSI RS for TRS.

In some example embodiments, in case of FR1, the symbol combination may be one of the following {0, 4}, {1, 5}, {2, 6}, {3, 7}, {4, 8}, {5, 9}, {6, 10}, {7, 11}, {8, 12} or {9, 13}.

In some example embodiments, performing the communications with the second apparatus 120 may comprise: performing, based on the transmission format indicator and the NZP CSI RS for tracking RS configuration, the communications on the SBFD slot, the communications comprising: transmitting uplink transmissions to the second apparatus 120, and receiving NZP CSI RS for tracking RS from the second apparatus 120.

In some example embodiments, the two consecutive slots may be periodic or aperiodic slots.

In some example embodiments, the NZP CSI RS for TRS configuration and the transmission format indicator may be comprised in the same message or at least two different messages.

In some example embodiments, the transmission format indicator may be a subband SFI.

In some example embodiments, the first apparatus 110 may a terminal apparatus and the second apparatus 120 may be a network apparatus.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1A may comprise means for performing the respective operations of the method 600. The means may be implemented in any suitable form. For example, the means may be implemented in a circuitry or software module. The second apparatus may be implemented as or included in the second apparatus 120 in FIG. 1A.

In some example embodiments, the second apparatus comprises means for transmitting, to a first apparatus, configuration information comprising a transmission format indicator, wherein the transmission format indicator is to be applied to a sub-band or a group of sub-bands and is to be applied to a plurality of sub-resources in time domain comprised in an SBFD slot, wherein the plurality of sub-resources are a plurality of symbols comprising at least one SBFD symbol and at least one non-SBFD symbol; and means for performing, with the first apparatus, communications on the plurality of sub-resources based at least in part on the configuration information.

In some example embodiments, the transmission format indicator may indicate the first part of the plurality of sub-resources are used for uplink transmissions.

Alternatively, in some example embodiments, the transmission format indicator may indicate the last part of the plurality of sub-resources are used for uplink transmissions.

Alternatively, in some example embodiments, the transmission format indicator may indicate the first part of the plurality of sub-resources are used for downlink transmissions.

Alternatively, in some example embodiments, the transmission format indicator may indicate the last part of the plurality of sub-resources are used for downlink transmissions.

In some example embodiments, the SBFD slot belongs to a plurality of continuous slots, and if the SBFD slot is the first slot of the plurality of slots, the format indicator may indicate the last part of the plurality of sub-resources are used for uplink transmissions.

In some example embodiments, the SBFD slot belongs to a plurality of continuous slots, and if the SBFD slot is the last slot of the plurality of slots, the format indicator may indicate the first part of the plurality of sub-resources are used for uplink transmissions.

In some example embodiments, the configuration information may further comprise: an NZP CSI RS for TRS configuration for two consecutive slots comprising the SBFD slot and a further slot.

In some example embodiments, the NZP CSI RS for TRS configuration indicates a same symbol combination corresponding to the two consecutive slots, indicating resources used for transmitting the NZP CSI RS for tracking RS.

Alternatively, in some example embodiments, the NZP CSI RS for TRS configuration indicates two different symbol combinations corresponding to the SBFD slot and the further slot respectively, indicating the resources used for transmitting the NZP CSI RS for TRS.

In some example embodiments, in case of FR1, the symbol combination may be one of the following {0, 4}, {1, 5}, {2, 6}, {3, 7}, {4, 8}, {5, 9}, {6, 10}, {7, 11}, {8, 12} or {9, 13}.

In some example embodiments, means for performing the communications with the second apparatus comprises: means for performing, based on the transmission format indicator and the NZP CSI RS for tracking RS configuration the communications on the SBFD slot, where the communications comprise: receiving uplink transmissions from the first apparatus, and transmitting NZP CSI RS for tracking RS to the first apparatus.

In some example embodiments, the two consecutive slots may be periodic or aperiodic slots.

In some example embodiments, the NZP CSI RS for TRS configuration and the transmission format indicator may be comprised in the same message or at least two different messages.

In some example embodiments, the transmission format indicator may be a subband SFI.

In some example embodiments, the first apparatus 110 may a terminal apparatus and the second apparatus 120 may be a network apparatus.

In some example embodiments, the first apparatus is a terminal apparatus and the second apparatus is a network apparatus.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

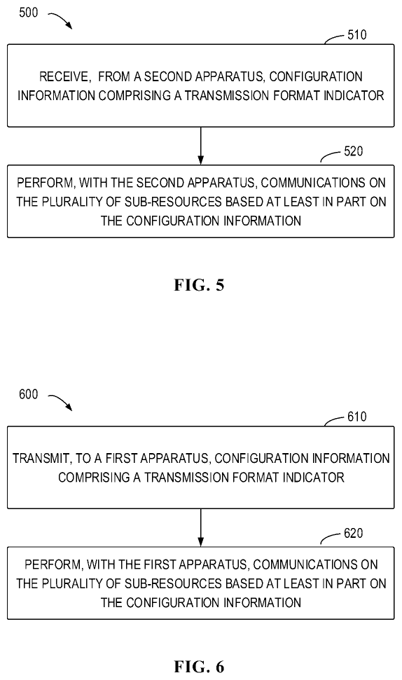

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

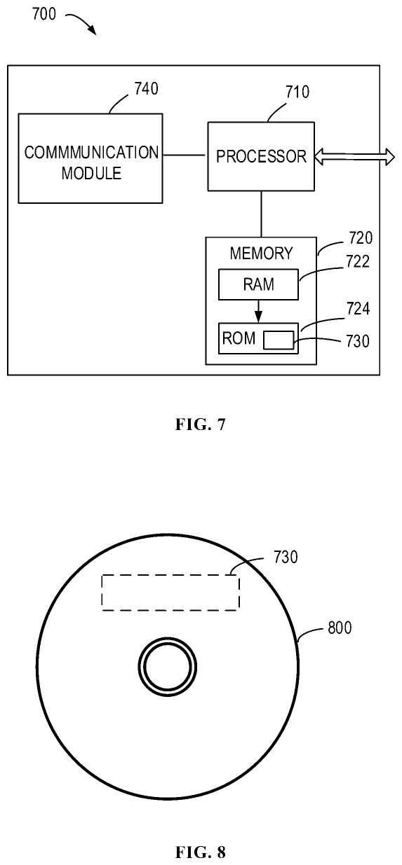

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
receive, from a second apparatus, configuration information comprising a transmission format indicator, wherein the transmission format indicator is to be applied to a sub-band or a group of sub-bands and is to be applied to a plurality of sub-resources in time domain comprised in a subband non-overlapping full duplex (SBFD) slot, wherein the plurality of sub-resources are a plurality of symbols comprising at least one SBFD symbol and at least one non-SBFD symbol; and
perform, with the second apparatus, communications on the plurality of sub-resources based at least in part on the configuration information.

2. The first apparatus of claim 1, wherein the transmission format indicator indicates at least of the following:
the first part of the plurality of sub-resources are used for uplink transmissions,
the last part of the plurality of sub-resources are used for uplink transmissions,
the first part of the plurality of sub-resources are used for downlink transmissions, or
the last part of the plurality of sub-resources are used for downlink transmissions.

3. The first apparatus of claim 1, wherein the SBFD slot belongs to a plurality of continuous slots, and wherein,
if the SBFD slot is the first slot of the plurality of slots, the format indicator indicates the last part of the plurality of sub-resources are used for uplink transmissions, or
if the SBFD slot is the last slot of the plurality of slots, the format indicator indicates the first part of the plurality of sub-resources are used for uplink transmissions.

4. The first apparatus of claim 1, wherein the configuration information further comprises:
a non-zero power (NZP) channel state information (CSI) reference signal (RS) for tracking RS (TRS) configuration for two consecutive slots comprising the SBFD slot and a further slot.

5. The first apparatus of claim 4, wherein the NZP CSI RS for TRS configuration indicates one of the following:
a same symbol combination corresponding to the two consecutive slots, indicating resources used for transmitting the NZP CSI RS for TRS, or
two different symbol combinations corresponding to the SBFD slot and the further slot respectively, indicating the resources used for transmitting the NZP CSI RS for TRS.

6. The first apparatus of claim 5, wherein in case of frequency range 1 (FR1), the symbol combination is one of the following (0, 4), (1, 5), (2, 6), (3, 7), (4, 8), (5, 9), (6, 10), (7, 11), (8, 12) or (9, 13).

7. The first apparatus of claim 4, wherein performing the communications with the second apparatus comprises:
performing, based on the transmission format indicator and the NZP CSI RS for TRS configuration, the communications on the SBFD slot, the communications comprising:
transmitting uplink transmissions to the second apparatus, and
receiving NZP CSI RS for TRS from the second apparatus.

8. The first apparatus of claim 4, wherein the two consecutive slots are periodic or aperiodic slots.

9. The first apparatus of claim 4, wherein the NZP CSI RS for TRS configuration and the transmission format indicator are comprised in the same message or at least two different messages.

10. The first apparatus of claim 1, wherein the transmission format indicator is a subband slot format indicator (SFI).

11. The first apparatus of claim 1, wherein the first apparatus is a terminal apparatus and the second apparatus is a network apparatus.

12. A second apparatus comprising:
at least one processor; and
at least one memory storing instructions that, when executed by the at least one processor, cause the second apparatus at least to:
transmit, to a first apparatus, configuration information comprising a transmission format indicator, wherein the transmission format indicator is to be applied to a sub-band or a group of sub-bands and is to be applied to a plurality of sub-resources in time domain comprised in a subband non-overlapping full duplex (SBFD) slot, wherein the plurality of sub-resources are a plurality of symbols comprising at least one SBFD symbol and at least one non-SBFD symbol; and
perform, with the first apparatus, communications on the plurality of sub-resources based at least in part on the configuration information.

13. The second apparatus of claim 12, wherein the transmission format indicator indicates at least of the following:
the first part of the plurality of sub-resources are used for uplink transmissions,
the last part of the plurality of sub-resources are used for uplink transmissions,
the first part of the plurality of sub-resources are used for downlink transmissions, or
the last part of the plurality of sub-resources are used for downlink transmissions.

14. The second apparatus of claim 12, wherein the SBFD slot belongs to a plurality of continuous slots, and wherein,
if the SBFD slot is the first slot of the plurality of slots, the format indicator indicates the last part of the plurality of sub-resources are used for uplink transmissions, or
if the SBFD slot is the last slot of the plurality of slots, the format indicator indicates the first part of the plurality of sub-resources are used for uplink transmissions.

15. The second apparatus of claim 12, wherein the configuration information further comprises:
a non-zero power (NZP) channel state information (CSI) reference signal (RS) for tracking RS (TRS) configuration for two consecutive slots comprising the SBFD slot and a further slot.

16. The second apparatus of claim 15, wherein the NZP CSI RS for TRS configuration indicates one of the following:
a same symbol combination corresponding to the two consecutive slots, indicating resources used for transmitting the NZP CSI RS for TRS, or
two different symbol combinations corresponding to the SBFD slot and the further slot respectively, indicating the resources used for transmitting the NZP CSI RS for TRS.

17. The second apparatus of claim 16, wherein in case of frequency range 1 (FR1), the symbol combination is one of the following (0, 4), (1, 5), (2, 6), (3, 7), (4, 8), (5, 9), (6, 10), (7, 11), (8, 12) or (9, 13).

18. The second apparatus of claim 15, wherein performing the communications with the second apparatus comprises:
performing, based on the transmission format indicator and the NZP CSI RS for TRS configuration, the communications on the SBFD slot, the communications comprising:
receiving uplink transmissions from the first apparatus, and
transmitting NZP CSI RS for TRS to the first apparatus.

19. The second apparatus of claim 15, wherein the two consecutive slots are periodic or aperiodic slots.

20-22. (canceled)

23. A method comprising:
receiving, at a first apparatus and from a second apparatus, configuration information comprising a transmission format indicator, wherein the transmission format indicator is to be applied to a sub-band or a group of sub-bands and is to be applied to a plurality of sub-resources in time domain comprised in a subband non-overlapping full duplex (SBFD) slot, wherein the plurality of sub-resources are a plurality of symbols comprising at least one SBFD symbol and at least one non-SBFD symbol; and
performing, with the second apparatus, communications on the plurality of sub-resources based at least in part on the configuration information.

24-25. (canceled)
